(19) United States
(12) Patent Application Publication
(10) Pub. No.: US 2006/0086377 A1
(43) Pub. Date: Apr. 27, 2006

(54) Self-flushing basement drainage pipe

(75) Inventors: Robert W. Showler, Davison, MI (US); Stephen P. Rivette, Louisville, KY (US); Donald M. Henry, Washington Twp, MI (US); Robert Clarke, Moscow, PA (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(73) Assignee: MICRON TECHNOLOGY, INC., Boise, ID (US)

(21) Appl. No.: 10/969,823

(22) Filed: Oct. 21, 2004

(51) Int. Cl. B08B 9/00

(52) U.S. Cl. 134/22.12; 134/166 R; 134/169 R; 134/115 R

(57) ABSTRACT

A drainage pipe for use in a basement waterproofing system includes an interior cleaning device that includes a plurality of openings to allow fluid, such as air or water, to be forced out of the pipe and clean debris within the drainage pipe. The drainage pipe also includes an exterior cleaning device that includes a spray nozzle affixed to an exterior surface of the drainage pipe. The exterior spray nozzle allows fluid and debris to be removed from areas outside the pipe.

### BACKGROUND

Drainage pipes have been effective at removing water from a basement. Some prior drainage systems include a drainage pipe having a rectangular or square cross-section and a plurality of openings located at lower sidewall portions. These openings allow water to flow into the pipe from the surrounding area, thus eliminating water on the basement floor. Some limitations of the prior systems include difficulty in assembling the systems, the expense of the systems, the lack of system strength due to their configuration, and clogging of the drainage system.

### SUMMARY

The present invention provides a drainage pipe which is submerged within the perimeter of the basement floor. The drainage pipe directs water away from the foundation of the structure. The pipe includes a plurality of openings located along its lower sidewalls. The spaced holes allow fluid such as air or water to be forced out of the pipe and clean debris from the drainage pipe. The drainage pipe also includes a spray nozzle affixed to an exterior surface of the drainage pipe. The exterior spray nozzle allow fluid and debris to be removed from the footer side of the pipe.

The present invention provides a self-flushing drainage apparatus for use in a basement waterproofing system that includes a hollow drainage pipe having a length, an upper interior surface, an exterior surface, an outlet, and a plurality of spaced openings therein, the plurality of spaced openings permitting water to enter the hollow drainage pipe from an area surrounding a foundation of an associated structure; a cleaning means affixed to the upper interior surface, such that the cleaning means provides a pressurized fluid to said hollow drainage pipe to remove associated debris accumulated therein; and a cleaning means affixed to the upper exterior surface, such that the cleaning means provides a pressurized fluid to the exterior of the hollow drainage pipe to remove associated debris accumulated from a footer area outside of the drainage pipe.

In another aspect the present invention provides a self-flushing drainage pipe that includes an upper section having an inverted U-shaped cross-sectional profile, the upper section including the upper interior surface; and a lower section having a U-shaped cross-sectional profile; and an embracing means for selectively securing the upper section to the lower section.

In one embodiment, the drainage pipe is rectangular. In another embodiment, the cleaning means includes a tube having a plurality of spaced holes therein. In another embodiment, the cleaning means includes a spray nozzle.

### BRIEF DESCRIPTION OF THE DRAWINGS

Embodiments of the invention are pointed out with particularity in the appended claims. However, a more complete understanding of the inventive subject matter may be derived by referring to the detailed description when considered in connection with the figures, wherein like reference numbers refer to similar items throughout the figures, and:

FIG. 1 is a perspective view of the drainage system of an example embodiment of the invention.

FIG. 2 is a perspective view showing the self-flushing means of an example embodiment of the invention.

FIG. 3A is a cross-sectional end view of the drainage system of an example embodiment of the invention.

FIG. 3B is a cross-sectional side view of the drainage system of an example embodiment of the invention.

FIG. 4A is a cross-sectional view showing one example embodiment of the invention.

FIG. 4B is a cross-sectional view showing another example embodiment of the invention.

FIG. 5 is a flow diagram of a method showing an example embodiment of the invention.

### DETAILED DESCRIPTION

In the following detailed description, reference is made to the accompanying figures which form a part hereof, and in which is shown by way of illustration specific embodiments in which the invention can be practiced. These embodiments are described in sufficient detail to enable those skilled in the art to practice the invention, and it is to be understood that the embodiments can be combined, or that other embodiments can be utilized and that structural and material changes can be made without departing from the spirit and scope of the present invention. The following detailed description provides examples and the scope of the present invention is defined by the appended claims and their equivalents.

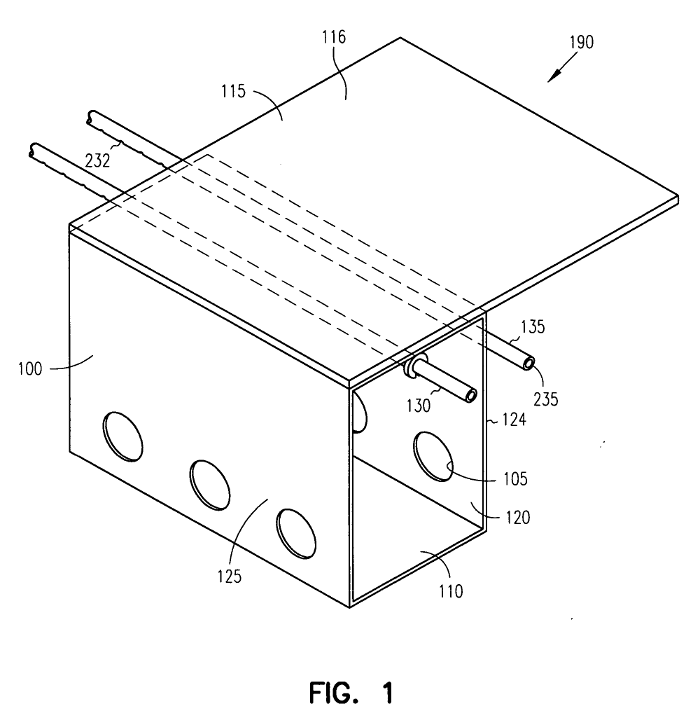

Referring now to the drawings, which are for purposes of illustrating an example embodiment of the invention only and not for purposes of limiting the same, FIG. 1 shows a waterproofing system 190 that includes a hollow drainage pipe 100 and an upper portion 115, such as plate 116, that is closely positioned with respect to the hollow drainage pipe 100. The hollow pipe 100 is generally placed inside the perimeter of an edifice and the plate 116 or upper portion 115 generally bridges the space between the hollow pipe 100 and the footings. The hollow drainage pipe 100 includes a plurality of openings 105 therein for allowing water from outside the drainage pipe 100 to enter the drainage pipe 100 and flow to a drainage site. In one embodiment, the drainage site may be a sump basket in a residential dwelling. The hollow drainage pipe also includes an interior surface 120, an exterior surface 125, an interior cleaning device 130, and an exterior cleaning device 135 The interior cleaning device 130 removes and or dislodges debris that may accumulate within the drainage pipe 100 and clog the openings 105. Generally, the interior cleaning device 130 is affixed to the interior surface 120, and spaced from the lowermost part of drainage pipe 100, such as the base 110. The interior cleaning device 130 directs fluid, such as water or the like, toward the interior surface 120 of the drainage pipe 100 in order to remove and or dislodge any accumulated debris. The hollow drainage pipe 100, in some embodiments, is generally set with a selected amount of fall or slope, so that a fluid will flow along the interior surface 120 at the base 110 of the hollow pipe toward the drainage site. In still other embodiments, the amount of fall or slope associated with the hollow drainage pipe 100 provides for sufficiently fast flows of fluid to prevent debris from settling out of the fluid and to carry the debris to the drainage site. In another embodiment of the invention, the fluid is pressurized or produces a pressure to produce the fluid flow along the base 110 of the interior surface 120 of the hollow drainage pipe 100.

In the example embodiment shown in FIG. 1, the exterior cleaning device 135 is affixed to the exterior surface 125 of the hollow drainage pipe 100. In the embodiment, the exterior cleaning device is affixed to the exterior surface 125 near the plate 116. The exterior cleaning device 135 is positioned between the hollow drainage pipe 100 and a footer of a building. In other words, the exterior cleaning device 135 is positioned on the footer side of drainage pipe 100 and includes openings or nozzles for directing fluid at the exterior surface 125 closest to the footings. In some embodiments, the exterior cleaning device 135 also directs fluid to the area between the footing and the drainage pipe 100. The exterior cleaning device 135 is designed to remove algae, mud and debris from a footer side of drainage pipe 100.

The exterior cleaning device 135 includes a tube 235. The tube 235 has an associated length that conforms generally to the length of the drain pipe 100. As shown in FIG. 1, the hollow drain pipe 100 is shortened section of the drain pipe and the tube 235 is elongated for the sake of illustration. In one embodiment, the inside diameter of the tube 235 is in the range of 0.375 inches (9.525 mm) to 1.5 inches (38.1 mm). The tube 235 has small holes 232 located along its length such that when a fluid is forced through the tube 235, the fluid exits these holes 232 to produce a spray of fluid out of the holes 232 in a downward direction or in a direction toward the base 110 of the hollow drain tube 100. The pressure at which the fluid sprays out of the holes 232 is dependent upon the size of the holes 232 and the fluid pressure. In some embodiments, the diameter of each hole 232 is in the range of 0.0156 inches (0.397 mm) to 0.5 inches (12.7 mm). In another embodiment, several of the holes 232 are configured such that the fluid sprays out of the tube 235 at a predetermined angle measured with respect to a sidewall 124 of the exterior surface 125. The holes 232 may be located anywhere along the perimeter and length of the pipe 100. This angled spray acts to push the debris into the pipe 100.

Either of the interior cleaning device 130 or the exterior cleaning device 135 can take on a variety of shapes and configurations. Each cleaning device 130, 135 is generally adapted to attach to a pressurized fluid source. Furthermore, in addition to connecting a water source to the system, the system contemplates other sources which can be utilized to remove debris from the pipe 100. For example, an air pressure hose can be connected to the interior cleaning device 130. Thus, by providing air pressure within the pipe 100 the debris may be moved towards the exit area and/or openings of the pipe 100. Air could also be used in the exterior cleaning device 135 to move debris into the pipe 100.

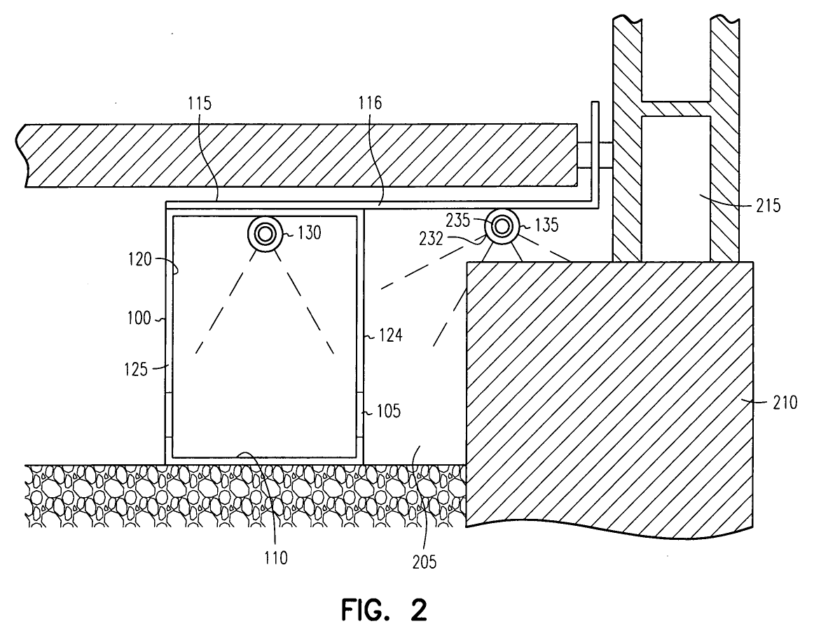

FIG. 2 shows a perspective view of a waterproofing system according to another example embodiment. FIG. 2 shows the drainage pipe as used in a basement waterproofing system. The basement foundation has a footer 210 and hollow cores 215 that have open centers vertically aligned in the wall to allow moisture from within the wall to flow out and drain into open area 205 which is formed in any suitable manner adjacent to the inner wall of the footer 210.

Drainage pipe 100 is located within open area 205 and is designed to remove water from open area 205. The exterior cleaning device 135 is located within open area 205 and on the exterior side of drainage pipe 100. The exterior cleaning device 135 is designed to remove algae, mud and debris from the footer side of drainage pipe 100. Water accumulating in open area 205 enters drainage pipe 100 through holes 105 and is removed in a conventional manner. Any mud or debris that remains in open area 205 is flushed out via the exterior cleaning device 135 into drainage pipe 100 and removed. In FIG. 2 the exterior cleaning device 135 and the tube 235 associated with it are affixed to the plate 116. The tube 235 includes 232 are configured such that the fluid sprays out of the tube 235 at a predetermined angle measured with respect to a sidewall 124 of the exterior surface 125. The holes 232 may be located anywhere along the perimeter and length of the pipe 100. This angled spray acts to push the debris into the pipe 100. The tube also includes openings 234 that produce an angled spray toward the top of the footer 210 and toward the open space 205 between the hollow drainage pipe 100 and the footer 210.

The interior cleaning device 130 or the exterior cleaning device 135 can take on a variety of shapes and configurations. Each cleaning device 130, 135 can attach to a pressurized fluid source. In addition, the drainage pipe 100 can also take on a variety of shapes and configurations. The drainage pipe 100 have a cross-sectional area that is square, rectangular or circular, or any other shape. The openings 105 in the drainage pipe can also take on a variety of shapes and sizes.

In one application, a wet basement is fixed by removing the basement floor above the footings of the edifice. Material is removed, the drainage pipe 100 and the external cleaning apparatus 135 are installed and hooked to a pressurized source of fluid. In one embodiment, the external cleaning apparatus 135 is attached to the side wall 124 closest to the footing 210 on the exterior surface 125 of the drainage pipe 100. In another embodiment, the external cleaning apparatus 135 is attached to the plate 116 somewhere between the side wall 124 and the footing 210 on the exterior surface 125 of the drainage pipe 100. Fill material, such as coarse fill material like rock or gravel, can be added. The plate 116 is placed over the drainage pipe 100. The floor, such as a cement floor, can be poured over the plate 116. The exterior cleaning apparatus 135 and the interior cleaning apparatus 130 can be pressurized with fluid on a periodic basis or otherwise to flush the drainage system.

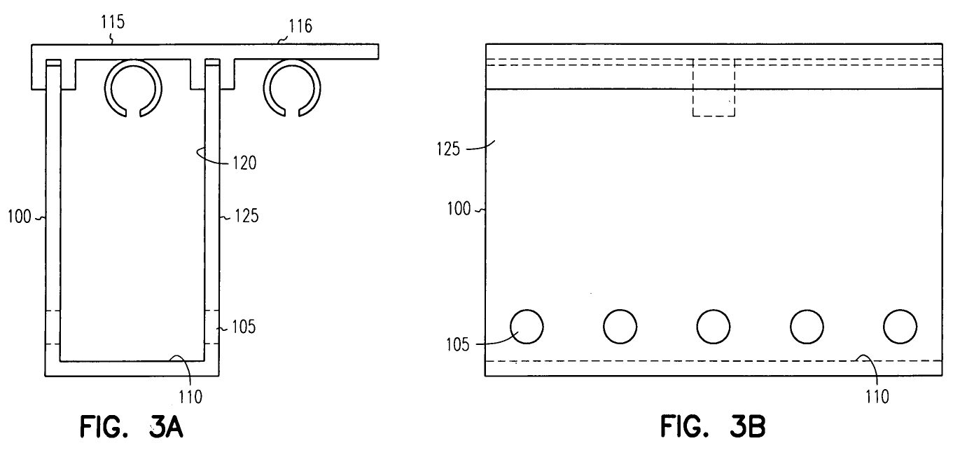

FIG. 3 shows a cross-sectional view of the drainage system of the present invention. FIG. 3A shows a cross-sectional view of drainage pipe 100 with openings 105 that are designed to flush out debris and mud from the pipe. Openings 105 are spaced approximately 3 inches apart and sized in such a way that water will be forced out in one direction toward the exit point of the system. FIG. 3B shows a side view of drainage pipe 100 with openings 105.

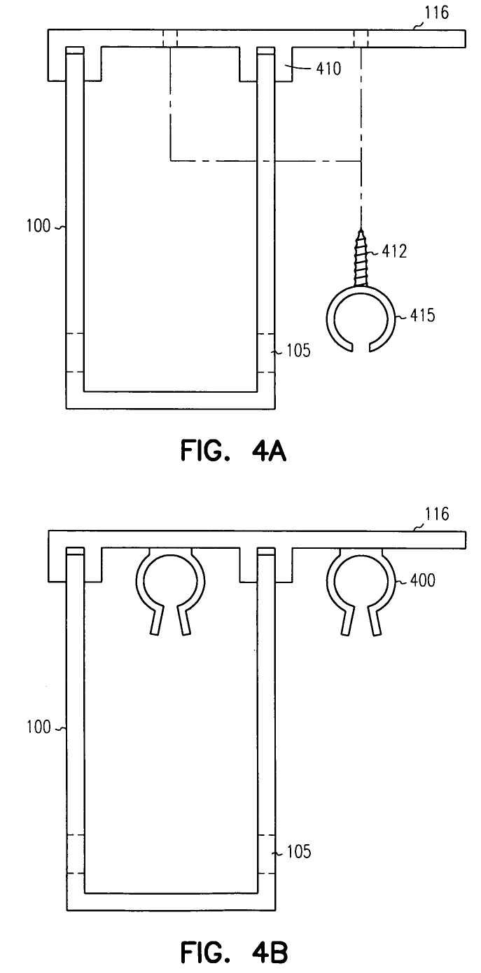

FIG. 4A shows an end view of a drain pipe showing one embodiment of the present invention. In one embodiment, the drain pipe 100 is adapted to hold the interior cleaning device 130 and the exterior cleaning device 135 using a pipe clip 415. A cap 116 is snap fit with a fastener 410. The pipe clips 415 can be held in position by any suitable fastening method, including a clip 415 having a threaded end 412 which is attached to the exterior portion of the pipe 100, to the cap 116, or to a portion of the foundation (shown in FIG. 2). The pipe clip 415 can also be used for fastening a pipe on the interior of the drain pipe 100.

FIG. 4B shows an end view of a drain pipe showing another embodiment of the invention. As shown, a pipe clip 400 may be attached to the inner wall of the drain pipe 100, to the cap 116, or to the foundation (see FIG. 2) by an adhesive. It is also contemplated that the pipe clips 400 may be attached to inner wall of the foundation in other ways without departing from the inventive aspects of the device. In addition to having threaded ends, the pipe clips could be snap fit, or press fit into openings in or near the drain pipe 100.

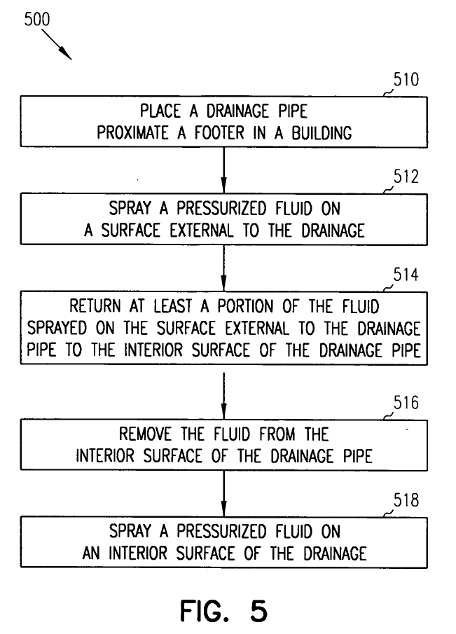

FIG. 5 is a flow diagram of a method 500, showing an embodiment of the invention. The method 500 includes placing a drainage pipe proximate a footer in a building 510, and spraying a pressurized fluid on a surface external to the drainage pipe 512. In some embodiments, the method 500 also includes returning at least a portion of the fluid sprayed on the surface external to the drainage pipe to the interior surface of the drainage pipe 514, and removing the fluid from the interior surface of the drainage pipe 516. Spraying a pressurized fluid 512 includes placing a tube having at least two openings therein in fluid communication with a pressurized source of fluid. In another embodiment, spraying a pressurized fluid 512 includes placing a tube with openings therein, and having a length less than an inside perimeter of the footings and greater than the outside perimeter of the drainage pipe, near the external surface, and placing the tube having openings therein in fluid communication with a source of pressurized fluid. In some embodiments, the method 500 also includes spraying a pressurized fluid on an interior surface of the drainage pipe 518.

The foregoing description of the specific embodiments reveals the general nature of the inventive subject matter sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the embodiments of the invention are intended to embrace all such alternatives, modifications, equivalents and variations as fall within the spirit and broad scope of the appended claims.

What is claimed is:

1. A self-flushing drainage apparatus for use in a basement waterproofing system comprising:
a hollow drainage pipe having a length, an upper interior surface, an exterior surface, an outlet, and a plurality of spaced openings therein, the plurality of spaced openings permitting water to enter the hollow drainage pipe from an area surrounding a foundation of an associated structure;
an interior cleaning means affixed to the interior surface, such that the interior cleaning means provides a pressurized fluid to said hollow drainage pipe to remove associated debris accumulated therein; and,
an exterior cleaning means affixed to the exterior surface, such that the exterior cleaning means provides a pressurized fluid to the exterior of the hollow drainage pipe to remove associated debris accumulated from a footer area outside of the drainage pipe.

2. The self-flushing drainage apparatus of claim 1 wherein the drainage pipe is rectangular.

3. The self-flushing drainage apparatus of claim 1 wherein the drainage pipe comprises:
an upper section having an inverted U-shaped cross-sectional profile, the upper section including the upper interior surface;
a lower section having a U-shaped cross-sectional profile; and,
embracing means for selectively securing the upper section to the lower section.

4. The self-flushing drainage apparatus of claim 1 wherein the exterior cleaning means comprises a tube having a plurality of spaced holes therein.

5. The self-flushing drainage apparatus of claim 1 wherein the exterior cleaning means comprises a spray nozzle.

6. The self-flushing drainage apparatus of claim 1 further comprising a plurality of pipe clips affixed to a surface exterior of the pipe, the plurality of pipe clips for holding the exterior cleaning means.

7. The self-flushing drainage apparatus of claim 6 wherein the plurality pipe clips are affixed by a mechanical means.

8. The self-flushing drainage apparatus of claim 7 wherein the mechanical means includes a fastener.

9. The self-flushing drainage apparatus of claim 7 wherein the mechanical means includes an integrally molded pipe clip.

10. The self-flushing drainage apparatus of claim 6 wherein the plurality pipe clips are affixed by an adhesive.

11. A method comprising:
placing a drainage pipe proximate a footer in a building; and
spraying a pressurized fluid on a surface external to the drainage pipe.

12. The method of claim 11 further comprising spraying a pressurized fluid on an interior surface of the drainage pipe.

13. The method of claim 11 further comprising:
returning at least a portion of the fluid sprayed on the surface external to the drainage pipe on the interior surface of the drainage pipe; and
removing the fluid from the interior surface of the drainage pipe.

14. The method of claim 11 wherein spraying a pressurized fluid includes placing a tube having at least two openings therein in fluid communication with a pressurized source of fluid.

15. The method of claim 11 wherein spraying a pressurized fluid includes:
placing a tube with openings therein, and having a length less than an inside perimeter of the footings and greater than the outside perimeter of the drainage pipe, near the external surface; and
placing the tube having openings therein in fluid communication with a source of pressurized fluid.

16. A waterproofing system comprising:
a drainage pipe having a length, an upper interior surface, an exterior surface, an outlet, and a plurality of spaced openings therein, the plurality of spaced openings permitting water to enter the drainage pipe from an area surrounding a foundation of an associated structure;
an interior cleaning system within the interior of the drainage pipe adapted to remove debris within the drainage pipe by directing a pressurized fluid within the interior surface; and,
an exterior cleaning system positioned outside the drainage pipe adapted to direct debris into the drainage pipe by directing a pressurized fluid.

17. The waterproofing system of claim 16 wherein the exterior cleaning system is attached to an exterior surface of the drainage pipe.

18. The waterproofing system of claim 16 wherein the exterior cleaning system is attached to another surface spaced away from the exterior surface of the drainage pipe.

19. The waterproofing system of claim 16 further comprising a plate for positioning over the drainage pipe, the exterior cleaning system attached to the plate at a location spaced away from the exterior surface of the drainage pipe.
